(19) United States
(12) Patent Application Publication
(10) Pub. No.: US 2006/0267837 A1
(43) Pub. Date: Nov. 30, 2006

(54) Personal GPS location recorder

(76) Inventor: Richard Haberkern, Burbank, CA (US)

Correspondence Address: Richard Haberkern, 617 N Myers Street, Burbank, CA, 91506, US

(21) Appl. No.: 11/138,624

(22) Filed: May 26, 2005

(51) Int. Cl. G01S 5/14

(52) U.S. Cl. 342/357.06

(57) ABSTRACT

A small battery operated device with a single button, visible indicator such as an LED contains a GPS receiver, antenna, microprocessor, non-volatile memory and integrated USB port. This device can be configured through custom software to record its own location at pre-defined intervals into its non-volatile memory. Upon retrieval, the apparatus can be plugged into a computer's USB port to download all the recorded geographical location history. This data could then provide a detailed report of where the object to which it was attached has been during the previous hours or days.

### CROSS-REFERENCE TO RELATED APPLICATIONS

N/A

### STATEMENT REGARDING FEDERALLY SPONSORED RESEARCH

N/A

### REFERENCE TO SEQUENCE LISTINGS OR COMPUTER PROGRAM

N/A

### BACKGROUD OF THE INVENTION

The capacity to record a detailed location history through the use of GPS receivers on commercial equipment, automobiles and large shipments is commonplace in today's marketplace. Typically, recorded location histories are used to analyze employee productivity, verify long-haul trucking routes and other industrial or commercial applications. Devices capable of performing this function are cumbersome, complicated to install and offer limited battery life. While these existing systems are widely used by law enforcement, corporations and individuals, a need has arisen for an easy to use, miniature location recorder with longer battery life and customizable software features. A device of this nature would be capable of recording a detailed location history of children, packages or any other moving object. Additionally, an electronic apparatus of this size could be concealed or disguised for use in the monitoring of criminal or terrorist activities.

### SUMMARY OF THE INVENTION

The present invention, known as the Personal GPS Location Recorder, solves these needs by combining a GPS receiver, microprocessor, low power components, battery management software, integrated USB port and an ultra compact circuit board design. This invention has allowed for the complete Personal GPS Location Recorder, including batteries, to be reduced to the size of a large package of chewing gum. For added security, the unit can only be powered down by pressing a known sequence on the single button located on top of the device.

### BRIEF DESCRIPTION OF THE DRAWINGS

FIG. 1 is a perspective view of the front of the Personal GPS Location Recorder

FIG. 2 is a second perspective view of the rear of the Personal GPS Location Recorder

FIG. 3 is a scale reference of the invention and application example as a keychain.

FIG. 4 is a diagrammatic description of the Personal GPS Location Recorder circuit interaction.

FIG. 5 is a diagrammatic description of the Personal GPS Location Recorder attached to a personal computer for data retrieval, charging and software configuration.

### TECHNICAL FIELD

The invention relates to the electronic recording of received GPS data to be used in the collection of historical locations of people, packages or any other movable objects. More particular, it refers to an improved miniature location data logger that, once retrieved, connects to a computer's USB port and allows for the downloading of detailed location and route histories. Additionally, this retrieved geographic data can mapped or imported into third party software packages for detailed analysis.

### DETAILED BEST MODE DESCRIPTION

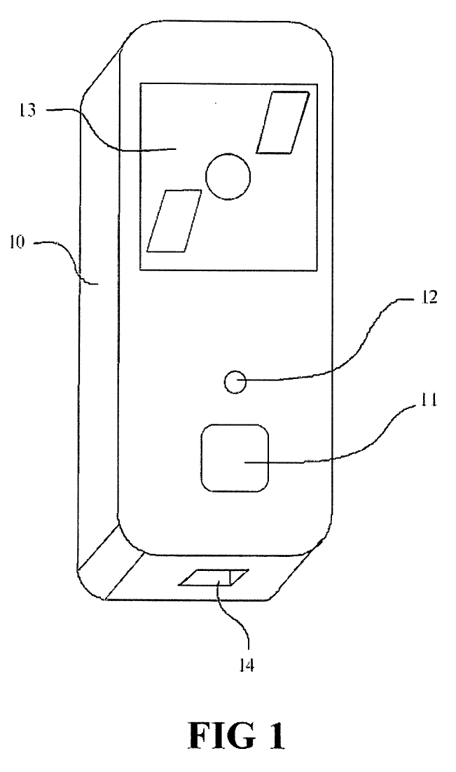

Referring to FIG. 1, the Personal GPS Location Recorder (PGLR) 10 includes a small electronic device in a plastic housing with a single pushbutton 11 and multi-colored light emitting diode (LED) 12. The pushbutton 11 acts as a function selector switch and also as a means to shut off the device when a specific sequence is pressed. The status of the PGLR 10 is indicated through the LED 12. A visible label 13 marks the location of the internal GPS antenna which should face towards the sky for optimal satellite signal reception. An integrated Universal Serial Bus (USB) port 14 allows for direct connection to a personal computer.

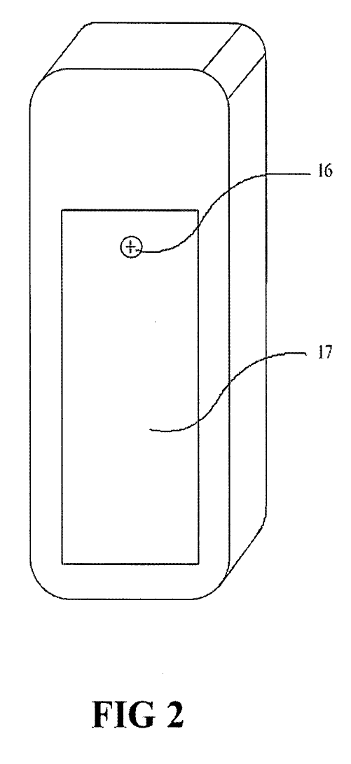

Referring to FIG. 2, the battery compartment 17 is secured with a small screw 16 to prevent easy battery removal.

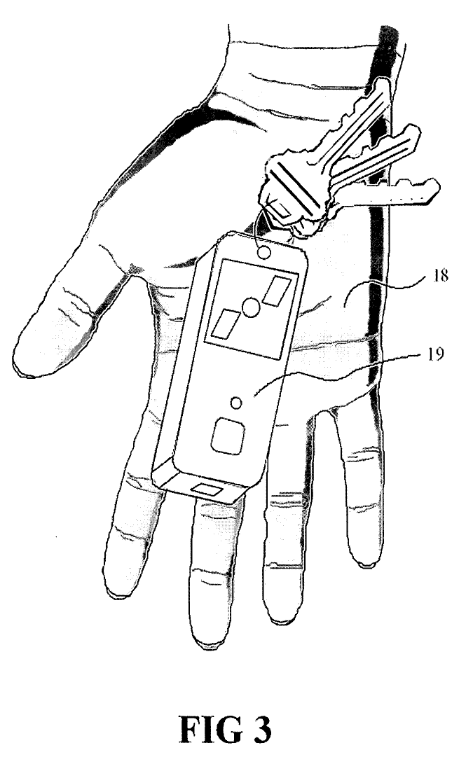

Referring to FIG. 3, The PGLR 10 can be used as a keychain 19 and fits into the palm of one's hand 18.

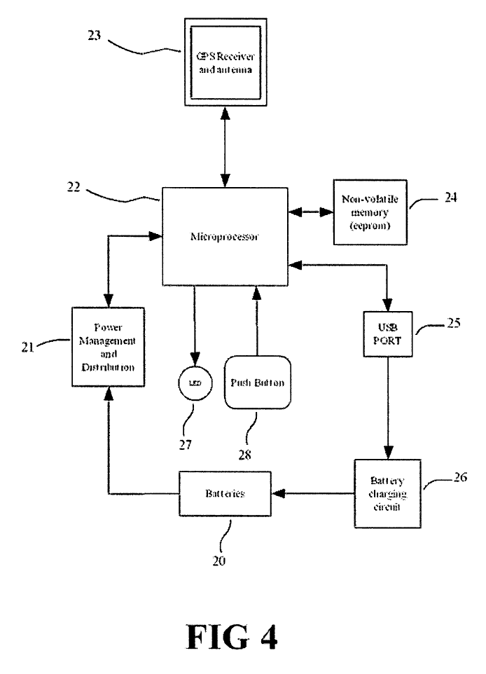

Referring to FIG. 4, the PGLR 10 contains a single circuit board with microprocessor 22 and non-volatile memory 24. A GPS antenna and receiver 23 sends current location data to the microprocessor 22 to be recorded into non-volatile memory 24. The status of a pushbutton 28 is sensed by the microprocessor 22. The system's status is indicated by the multi-colored LED 27. Standard batteries 20 power the PGLR 10. Power consumption and remaining battery life is monitored and optimized by electronic circuitry 20 and the microprocessor 22. The USB port 25 connects the PGLR 10 to a personal computer. Batteries can be recharged through electronic circuitry 26 powered by the USB port 25.

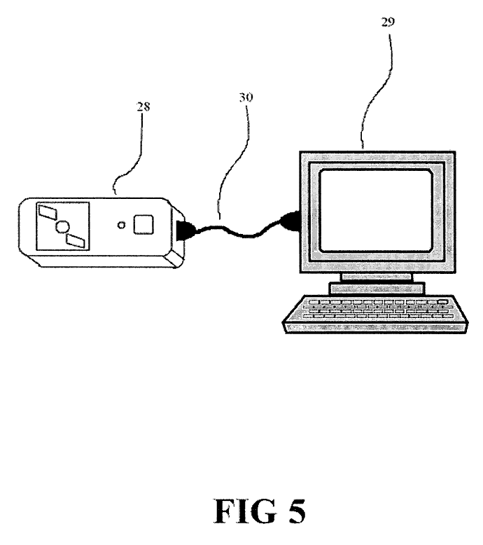

Referring to FIG. 5, data can be downloaded from the PGRL 28 to a personal computer 29 via a USB connection 30. The personal computer 29 contains specialized software included with the PGLR 28 for setting configuration options, uploading new control software and the retrieving of all the non-volatile memory's recorded data.

Having thus described the invention what is claimed and desired to be secured by Letters Patent is:

1. A miniature Personal GPS Location Recorder comprising:
A battery powered GPS location recorder with integrated USB port.
The GPS location recorder consists of a miniature GPS receiver, integrated antenna, microprocessor, non-volatile memory, batteries, a single pushbutton and multi colored LED contained in a small plastic housing;
The Personal GPS Location Recorder contains means for receiving a GPS signal to determine the geographical location of the apparatus and record this location into non-volatile memory.
This Personal GPS Location Recorder is plugged into a computer's USB port to allow for configuration, internal software updates and recorded data retrieval.
Battery life is maximized through low power electronic components, power consumption monitoring and optimization by the microprocessor's firmware.

2. This apparatus, according to claim 1 wherein the single button is used to issue certain commands to the microprocessor. As an example:
Pressing this button once turns on the LED to indicate satellite signal strength.
Pressing this button again will turn off the LED but the unit will continue to operate normally.
Pressing this button twice allows for the monitoring of battery condition.
Pressing the button in a pre-selected sequence will stop the microprocessor from recording its location and power down the unit.
The power down sequence is definable through the configuration software when connected to a computer.

3. The apparatus according to claim 2 can never be powered down unless:
a) The button is depressed in a specific sequence as programmed by the configuration software.
b) The batteries are removed.

4. The apparatus according to claim 1 is small enough to be hidden in a purse, package, clothing, child's schoolbag or can also be attached to a vehicle, shipping container or any object that needs its location history recorded.

5. The apparatus according to claim 1 can be disguised as a keychain, package of chewing gum or any other commonly used item.

6. The apparatus according to claim 1 can be powered by two standard AA or AAA batteries.

7. The apparatus according to claim 5 will also operate on rechargeable batteries that can be recharged through the USB port.

8. The apparatus according to claim 1 wherein the Personal GPS Location Recorder contains one circuit board.

9. The apparatus according to claim 7 wherein the circuit board contains surface mount electronic components, a GPS receiver, GPS antenna microprocessor, eeprom, battery connectors, pushbutton, LED and USB port.

10. The apparatus according to claim 1 wherein the Personal GPS Location Recorder is enclosed in a small plastic housing with dimensions no larger than two and one half (2½) inches long by one and one quarter (1¼) inches wide by three quarters (¾) of an inch high.

11. The apparatus, according to claim 1 wherein contains its own GPS antenna. No external hardware is required for normal operation.

12. The apparatus according to claim 1 can be directly connected to a computer via a standard USB port.

13. The apparatus according to claim 1 can have its internal software, also known as firmware, upgraded by the user via the integrated USB port.

14. The apparatus according to claim 1 allows the user to configure operating parameters and other user definable features through the USB port.

15. The apparatus according to claim 1 wherein the electronic circuit has unique design features and components to minimize power consumption.

16. Power consumption according to claim 13 averages less than ten (10) milliamps during normal operation.

17. The apparatus according to claim 13 uses internal software, also known as firmware to minimize overall power consumption.
